(19) United States
(12) Patent Application Publication
(10) Pub. No.: US 2012/0034384 A1
(43) Pub. Date: Feb. 9, 2012

(54) MOLELCULAR ADSORBER COATING

(75) Inventors: Sharon A. Straka, Glenelg, MD (US); Wanda C. Peters, Washington, DC (US); Jack J. Triolo, Severna Park, MD (US); Mark M. Hasegawa, Highland, MD (US); Kevin J. Novo-Gradac, Severna Park, MD (US); Cory B. Miller, Virginia Beach, VA (US); Nithin S. Abraham, Silver Spring, MD (US)

(73) Assignee: United States of America as represented by the Administrator of the National Aeronautics and Spac, Washington, DC (US)

(21) Appl. No.: 13/197,214

(22) Filed: Aug. 3, 2011

Related U.S. Application Data
(60) Provisional application No. 61/370,251, filed on Aug. 3, 2010.

(51) Int. Cl. B05D 5/00; B05D 1/02; B05D 3/02; B05D 3/10; B05D 3/00; C09D 1/00; B05D 1/36

(52) U.S. Cl. 427/307; 106/286.5; 427/421.1; 427/402; 427/372.2; 427/379

(57) ABSTRACT

A molecular adsorber coating for collecting and retaining outgassed molecular effluent may include a mass fraction of about 0.20 to about 0.40 of zeolite, a mass fraction of about 0.40 to about 0.80 of a binder, and a mass fraction of about 0.0 to about 0.30 of water. The mass ratio of the binder to the zeolite may be in a range of about 1.6 to about 2.4. The binder may comprise, on a mass basis, about 30 to about 40 percent particles of nonporous silica dispersed in a liquid phase.

### CROSS-REFERENCE TO RELATED APPLICATIONS

Priority is claimed to U.S. provisional patent application Ser. No. 61/370,251 filed on Aug. 3, 2010. The contents of provisional patent application Ser. No. 61/370,251 are expressly incorporated by reference herein.

### ORIGIN OF INVENTION

The invention described herein was made in the performance of work under a NASA contract and by employees of the United States Government and is subject to Public Law 96-517 (35 U.S.C. 5200 et seq.). The contractor has not elected to retain title to the invention.

### FIELD OF THE INVENTION

The invention relates to molecular adsorbers for collecting and retaining outgassed molecular effluent.

### BACKGROUND

Outgassed materials may have the potential to degrade the performance of for example, optical surfaces, thermal control surfaces, solar arrays, electronics, and detectors. As mission, satellite, and instrument performance requirements advance, the need to control adverse molecular contamination may be more critical. One method for controlling the outgassing of materials may be the use of molecular adsorber pucks. Zeolite-coated cordierite molecular adsorber pucks may be used to collect and retain outgassed molecular effluent emanating from materials.

Adsorber pucks may collect and retain outgassed molecular mass emanating from, for example, potting compounds, epoxies, tapes, and other materials. Collecting the outgassed molecular mass may minimize transfer of the outgassed molecular mass to critical surfaces, for example, optical and thermal surfaces on a spacecraft. However, adsorber pucks may require a substantial amount of valuable interior instrument space. For example, the Hubble Space Telescope may use over 60 adsorber pucks having diameters of about 3.5 inches.

The hardware required for mounting the pucks may also occupy much space. While adsorber pucks may be relatively inexpensive to fabricate, the pucks' support fixtures, screws, bolts, retaining hardware, and adsorber bonded inserts may require unique and costly fabrication. The mass of the pucks and the mass of the mounting hardware may impact total and distributed mass allocations, for example, on board a spacecraft.

A long-felt and unsolved need exists for a molecular adsorber that may occupy less space, have less mass, and be easier to install and apply than puck-type molecular adsorbers.

### SUMMARY

In one aspect, a molecular adsorber coating may include a mass fraction of about 0.20 to about 0.40 of zeolite, a mass fraction of about 0.40 to about 0.80 of binder, and a mass fraction of about 0.0 to about 0.30 of water. The mass ratio of the binder to the zeolite may be, for example, in a range of about 1.6 to about 2.4. The binder may he, for example, a silicate-based binder.

In another aspect, a method may include spraying a molecular adsorber coating onto a surface. Before spraying, the method may include treating the surface by one of applying a primer to the surface and etching the surface. After spraying, the method may include air drying the surface. Air drying may include air drying until water in the coating is evaporated from the surface.

After air drying, the method may include baking the surface at a temperature in a range of about 150-250° F. Baking may include baking for at least about two hours.

The invention will be better understood, and further objects, features, and advantages thereof will become more apparent from the following description of the preferred embodiments.

### DETAILED DESCRIPTION

A zeolite-type molecular adsorber coating may provide molecular adsorption and/or thermal control. The molecular adsorber coating may he used, for example, on the inside and/or outside of electronic boxes, on internal instrument surfaces and baffles, and on internal structural walls of spacecraft buses. The adsorber coating may reduce the need for costly structural fixtures for mounting adsorber pucks. The adsorber coating may have less mass than structural fixtures. The zeolite slurry may contain no organics or only trace organics. The zeolite slurry may cause no additional outgassing. The molecular adsorber coating may be used in areas where contaminants and volatiles need to be collected and contained, for example, in pharmaceutical production and chemical processing.

A zeolite-type molecular adsorber coating may operate as one or more of a thermal control coating with favorable thermal emittance properties and a contamination mitigation tool with adsorbing properties for outgassing materials. The molecular adsorber coating may be cheaper to use than adsorbers pucks, may have less mass than adsorber pucks, and may require less space than adsorber pucks. The adsorber coating may be advantageous in reducing subsystem hardware bakeouts, reducing detector cycling, preventing high voltage arcing, eliminating costly material selections, and lengthening mission operations.

The molecular adsorber coating may include zeolite, binder, and water. The zeolite may be virtually any type of zeolite. The zeolite particles may function as molecular sieves to capture and trap contaminants. In one embodiment, the zeolite may be an aluminosilicate type of zeolite.

The binder may function as glue that holds the molecular adsorber coating together. The binder may be, for example, various grades of Ludox® colloidal silica-based binders. The binder may contain, on a mass basis, between about 30 to about 40 percent suspensions of fine-sized spherical particles of nonporous silica dispersed in liquid phase. Other silicate-based binders may also be used.

The water component of the molecular adsorber coating may function to adjust the thickness of the coating. The thickness of the coating may be adjusted so that the coating may be used in a spray application process.

The mass fraction of zeolite in the molecular adsorber coating may be in a range of about 0.20 to about 0.40. The mass fraction of binder in the molecular adsorber coating may be in a range of about 0.40 to about 0.80. The mass fraction of water in the molecular adsorber coating may be in a range of about 0 to about 0.30. The mass fractions of the three components may vary depending on the desired mass ratio of binder to zeolite. In some embodiments, the mass ratio of binder to zeolite may be in a range of about 1.6 to about 2.4.

Example of Composition

A molecular adsorber coating has a mass ratio of binder to zeolite of about 1.8. The mass fraction of water in the coating is about 0.20. The mass fraction of binder in the coating is about 0.51 and the mass fraction of zeolite in the coating is about 0.29. The binder is a 40% suspension of Ludox® colloidal silica.

Example of Method of Making

The molecular adsorber coating may be formulated on a mass ratio basis using a laboratory bench scale method. The desired amount of binder is weighed and poured into an Erlenmeyer flask. The flask is then placed on a stir plate and a magnetic stirrer is used to thoroughly mix the contents of the coating. Next, the desired amount of zeolite is weighed out separately in a beaker or container. While stirring, zeolite is slowly transferred in small amounts into the flask containing the binder. Each small amount of zeolite is added to the binder in the flask once clumps are no longer visible and the contents of the coating appear to be very well mixed.

The zeolite is added slowly to the binder, rather than all at once, to prevent excessive clumping and/or a possible exothermic reaction effect. After the last remaining amounts of zeolite are added to the binder in the flask, the coating is continuously stirred until it reaches a homogeneous milky appearance. If the coating is too viscous, an additional amount of distilled water is stirred into the coating to make it the desired thickness. Lastly, the contents are stirred again thoroughly and transferred to a securely closed container for future spray application use.

Methods of Use

The molecular adsorber coating may be applied by a standard spray application process. The coating may be thoroughly mixed in a ball mill mixing jar and transferred into a spray gun cup. The spray gun may have adjustable settings. The desired settings are dependent on the desired thickness of the coating. Adjustable parameters of the spray gun may include air pressure, fluid flow pressure, atomizing pressure effect of the spray gun, and the distance from the nozzle tip of the spray gun to the surface to be coated.

Any type of surface may be treated with the molecular adsorber coating. The surface to be treated may be prepared for bonding with the molecular adsorber coating by applying a primer to the surface or by etching the surface. The primer may be, for example, zinc oxide/potassium silicate based primer, silica low outgassing epoxy primer, or silane based primer.

The molecular adsorber coating may be sprayed onto the surface to be treated. After the coating is applied, the surface may be air-dried until the water component of the coating evaporates from the coated surface and the coated surface appears to have a matte-like finish. Afterwards, the coated surface may be placed in an oven and baked between about 150-250° F. for final drying and curing. The coated surface may be baked in the oven for, for example, at least two hours to flash off water.

Test Results

Several formulations of the molecular adsorber coating having a mass ratio of binder to zeolite in a range of about 1.6 to about 2.4 were produced and tested. The tests included molecular adsorption, adhesion, thermal cycling, reflectivity, and emissivity.

Molecular adsorption capacitance and efficiency testing were conducted in the test facility used to test flight-qualified molecular adsorber pucks. The facility is a thermal vacuum chamber effusion cell with a cut-out for the model contaminant to emerge from the cell. A quartz crystal monitor was used to measure the flux of contaminants emerging from the cell. The contaminant source (stearyl alcohol) was maintained at a set temperature and the molecular adsorber sample was placed within the line of sight of the source, between the source and the exit of the effusion cell. Source temperatures were at 25 and 28 C while the molecular adsorber coating was under test. The sample coating was exposed to a stearyl alcohol source for 240 hours at 25 C and 160 hours at 28 C. The capture efficiency of the sample coating was about 80%.

Coating samples were tested for adhesion in accordance with ASTM D3359-97 standard using 3M #250 masking tape. In one section of a coating sample, a crosscut pattern (X cut) was made. After the X cut was made, the coating was evaluated before and after tape peels. The 3M masking tape was firmly pressed to each section, removed slowly, and then examined for signs of delamination. In some instances, a tape peel was made on a coating sample without cutting an X into the substrate, to illustrate adhesion without surface fracturing of the top coat. All coating samples passed the adhesion test.

Ideally, each coating sample should be thermally cycled before being tested for adhesion. Facility and time constraints limited the number of samples that could be thermally cycled prior to adhesion testing. Three of the samples that were tested for adhesion were thermally cycled prior to the adhesion testing. The thermal cycling was performed in a Veeco Bell Jar operating between +140 and −115 C. A total of 62 thermal cycles were achieved over a four day period.

A Perkin Elmer Lambda-19 instrument was used to perform reflectance measurements and solar absorptance measurements in accordance with ASTM E903-82 standard test method. The Lambda-19 instrument measures the reflectance of a sample's surface over the spectral range of 250-2400 nm at a 15 degree angle of incidence. A Gier-Dunkle DB-100 Infra Red Reflectometer was used to measure the normal emittance of coating samples following the ASTM E408-71 standard test method. The DB-100 measures the normal emittance of the surface from 5 to 40 microns. Emittance measurements were made at room temperature.

Solar absorptance and normal emittance measurements of coating samples were taken to evaluate the effect of the coating material applied over AZ Technology's AZ-93 thermal control paint. The AZ-93 thermal control paint without the molecular adsorber coating has a solar absorptance near 0.16 and a normal emittance of 0.92. After applying the molecular adsorber coating to the AZ-93, the measured solar absorptance and normal emittance were substantially the same as the uncoated AZ-93. In the case of substrates with a “raised ridge pattern,” the measured solar absorptance was more, about 0.18 to 0.19. The ridged pattern surface morphology caused the sample to act similar to a finned radiator. Measured emittance was about 0.92 to 0.93 across all coating samples, whether the substrate was “ridged” or not.

Compared to molecular adsorber pucks, the molecular adsorber coating may occupy less space, have less mass, and be easier to install and apply. Because the molecular adsorber coating may be sprayed onto surfaces, it may be used in areas where pucks may not be used. The molecular adsorber coating may be advantageous in reducing subsystem hardware bakeouts, reducing detector cycling, preventing high voltage arcing, eliminating costly material selections, and lengthening mission operations.

What is claimed is:

1. A molecular adsorber coating, comprising:
a mass fraction of about 0.20 to about 0.40 of zeolite;
a mass fraction of about 0.40 to about 0.80 of binder; and
a mass fraction of about 0.0 to about 0.30 of water.

2. The coating of claim 1, wherein a mass ratio of the binder to the zeolite is in a range of about 1.6 to about 2.4.

3. The coating of claim 1, wherein the binder is a silicate-based binder.

4. The coating of claim 2, wherein the binder comprises, on a mass basis, about 30 to about 40 percent particles of nonporous silica dispersed in a liquid phase.

5. The coating of claim 1, wherein the zeolite is an aluminosilicate type of zeolite.

6. A molecular adsorber coating, consisting essentially of:
a mass fraction of about 0.20 to about 0.40 of zeolite;
a mass fraction of about 0.40 to about 0.80 of binder; and
a mass fraction of about 0.0 to about 0.30 of water.

7. The coating of claim 6, wherein a mass ratio of the binder to the zeolite is in a range of about 1.6 to about 2.4.

8. The coating of claim 6, wherein the binder is a silicate-based binder.

9. The coating of claim 7, wherein the binder comprises, on a mass basis, about 30 to about 40 percent particles of nonporous silica dispersed in a liquid phase.

10. The coating of claim 6, wherein the zeolite is an aluminosilicate type of zeolite.

11. A method comprising spraying the coating of claim 1 onto a surface.

12. The method of claim 11, further comprising, before spraying, treating the surface by one of applying a primer to the surface and etching the surface.

13. The method of claim , further comprising, after spraying, air drying the surface.

14. The method of claim 13, wherein air drying includes air drying until water in the coating is evaporated from the surface.

15. The method of claim 13, further comprising, after air drying, baking the surface at a temperature in a range of about 150-250° F.

16. The method of claim 15, wherein baking includes baking for at least about two hours.

17. A method comprising spraying the coating of claim 6 onto a surface.

18. The method of claim 17, further comprising, before spraying, treating the surface by one of applying a primer to the surface and etching the surface.

19. The method of claim 17, further comprising, after spraying, air drying the surface.

20. The method of claim 19, wherein air drying includes air drying until water in the coating is evaporated from the surface.

21. The method of claim 19, further comprising, after air drying, baking the surface at a temperature in a range of about 150-250° F.

22. The method of claim 21, wherein baking includes baking for at least about two hours.
